(19) United States
(12) Patent Application Publication
(10) Pub. No.: US 2020/0267655 A1
(43) Pub. Date: Aug. 20, 2020

(54) DISCONTINUOUS RECEPTION PARAMETER ADAPTATION USING WAKE UP SIGNALING

(71) Applicant: QUALCOMM Incorporated, San Diego, CA (US)

(72) Inventors: Olufunmilola Omolade AWONIYI-OTERI, San Diego, CA (US); Tao LUO, San Diego, CA (US); Wooseok NAM, San Diego, CA (US); Peter Pui Lok ANG, San Diego, CA (US); Arumugam CHENDAMARAI KANNAN, San Diego, CA (US)

(21) Appl. No.: 16/774,999

(22) Filed: Jan. 28, 2020

Related U.S. Application Data
(60) Provisional application No. 62/806,362, filed on Feb. 15, 2019.

(51) Int. Cl. H04W 52/02

(52) U.S. Cl. CPC H04W 52/0235

(57) ABSTRACT

Various aspects of the present disclosure generally relate to wireless communication. In some aspects, a user equipment may receive, when operating in a connected discontinuous reception (CDRX) mode in accordance with a first set of discontinuous reception (DRX) parameters, a wake up signal that includes a second set of DRX parameters that is different from the first set of DRX parameters. The user equipment may operate in the CDRX mode in accordance with the second set of DRX parameters. Numerous other aspects are provided.

### CROSS-REFERENCE TO RELATED APPLICATION

This patent application claims priority to U.S. Provisional Patent Application No. 62/806,362, filed on Feb. 15, 2019, entitled “DISCONTINUOUS RECEPTION PARAMETER ADAPTATION USING WAKE UP SIGNALING,” and assigned to the assignee hereof. The disclosure of the prior Application is considered part of and are incorporated by reference in this patent application.

### FIELD OF THE DISCLOSURE

Aspects of the present disclosure generally relate to wireless communication, and to techniques and apparatuses for discontinuous reception parameter adaptation using wake up signaling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In some aspects, a method of wireless communication, performed by a user equipment (UE), may include receiving, when operating in a connected discontinuous reception (CDRX) mode in accordance with a first set of discontinuous reception (DRX) parameters, a wake up signal that includes a second set of DRX parameters that is different from the first set of DRX parameters; and operating in the CDRX mode in accordance with the second set of DRX parameters.

In some aspects, a UE for wireless communication may include memory and one or more processors operatively coupled to the memory. The memory and the one or more processors may be configured to receive, when operating in a CDRX mode in accordance with a first set of DRX parameters, a wake up signal that includes a second set of DRX parameters that is different from the first set of DRX parameters; and operate in the CDRX mode in accordance with the second set of DRX parameters.

In some aspects, a non-transitory computer-readable medium may store one or more instructions for wireless communication. The one or more instructions, when executed by one or more processors of a UE, may cause the one or more processors to: receive, when operating in a CDRX mode in accordance with a first set of DRX parameters, a wake up signal that includes a second set of DRX parameters that is different from the first set of DRX parameters; and operate in the CDRX mode in accordance with the second set of DRX parameters.

In some aspects, an apparatus for wireless communication may include means for receiving, when operating in a CDRX mode in accordance with a first set of DRX parameters, a wake up signal that includes a second set of DRX parameters that is different from the first set of DRX parameters; and means for operating in the CDRX mode in accordance with the second set of DRX parameters.

Aspects generally include a method, apparatus, system, computer program product, non-transitory computer-readable medium, user equipment, base station, wireless communication device, and processing system as substantially described herein with reference to and as illustrated by the accompanying drawings and specification appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3A is a block diagram conceptually illustrating an example of a frame structure in a wireless communication network, in accordance with various aspects of the present disclosure.

FIG. 3B is a block diagram conceptually illustrating an example synchronization communication hierarchy in a wireless communication network, in accordance with various aspects of the present disclosure.

FIG. 4 is a block diagram conceptually illustrating an example slot format with a normal cyclic prefix, in accordance with various aspects of the present disclosure.

FIG. 5 illustrates an example logical architecture of a distributed radio access network (RAN), in accordance with various aspects of the present disclosure.

FIG. 6 illustrates an example physical architecture of a distributed RAN, in accordance with various aspects of the present disclosure.

FIGS. 7A-7E are diagrams illustrating examples of discontinuous reception parameter adaptation using wake up signaling, in accordance with various aspects of the present disclosure.

FIG. 8 is a diagram illustrating an example process performed, for example, by a user equipment, in accordance with various aspects of the present disclosure.

### DETAILED DESCRIPTION

In some communications systems, such as New Radio (NR), power saving modes may be enabled for user equipment (UEs) to reduce power consumption. For example, operating in a connected discontinuous reception (CDRX) mode may reduce power consumption for a UE. In the CDRX mode, the UE may periodically transfer from a wake state, during which the UE may communicate with a base station (BS), to a sleep state, during which the UE may refrain from communicating with the BS, thereby reducing power consumption. The wake state may include a discontinuous reception (DRX) on duration, during which the UE may receive data transmissions, control transmissions, and/or the like from the BS.

Before or at a beginning of the DRX on duration, the UE may receive a wake up signal from the BS. The wake up signal may include information indicating whether the UE is to wake up for the DRX on duration to receive data from the BS or whether the UE is to skip the DRX on duration and remain in a sleep state to reduce power consumption. If the UE does not receive a wake up signal, the UE may remain in the sleep state until a next wake up signaling occasion (e.g., a next resource reserved for wake up signaling). After a wake up signaling occasion during which the UE does not receive a wake up signal, a next wake up signaling occasion may not occur for one or more DRX cycles.

A configuration of the one or more DRX cycles, and the presence of wake up signaling occasions therein, may be optimized based at least in part on a downlink data traffic pattern and configured using radio resource control (RRC) signaling. However, when the BS does not transmit or fails to successfully transmit a wake up signal, the UE may remain in the sleep state for excessive periods of time during which the BS may have data for transmission to the UE that remains queued or is dropped. Further, RRC signaling may be transmitted infrequently, resulting in DRX parameters persisting for a threshold period of time between RRC signaling occasions. When the downlink data traffic pattern changes, the DRX parameters may no longer be optimized for the downlink data traffic pattern. For example, a length of an on duration, an inactivity timer, an offset between a wake up signal and an on duration, and/or the like may no longer be optimized for the downlink data traffic pattern, resulting in an increase in downlink data latency, a decrease in power savings from using the CDRX mode, and/or the like. Although the BS may configure a plurality of DRX configurations for a plurality of different traffic types, this may not address downlink data traffic pattern changes within a same traffic type.

Some aspects described herein enable DRX parameter adaptation using wake up signaling. For example, a UE, operating in a CDRX mode in accordance with a first set of DRX parameters configured using RRC signaling, may receive a wake up signal that may include information identifying a second set of DRX parameters that is different from the first set of DRX parameters. In this case, the UE may transfer to operating in the CDRX mode in accordance with the second set of DRX parameters. Based at least in part on wake up signaling occasions occurring in between RRC signaling occasions, using wake up signaling for DRX parameter adaptation enables more frequent adjustment to DRX parameters. In this way, a UE and a BS ensure that DRX parameters may remain optimized to a downlink data traffic pattern, thereby reducing downlink data traffic latency, increasing power savings associated with the CDRX mode, and/or the like.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based at least in part on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

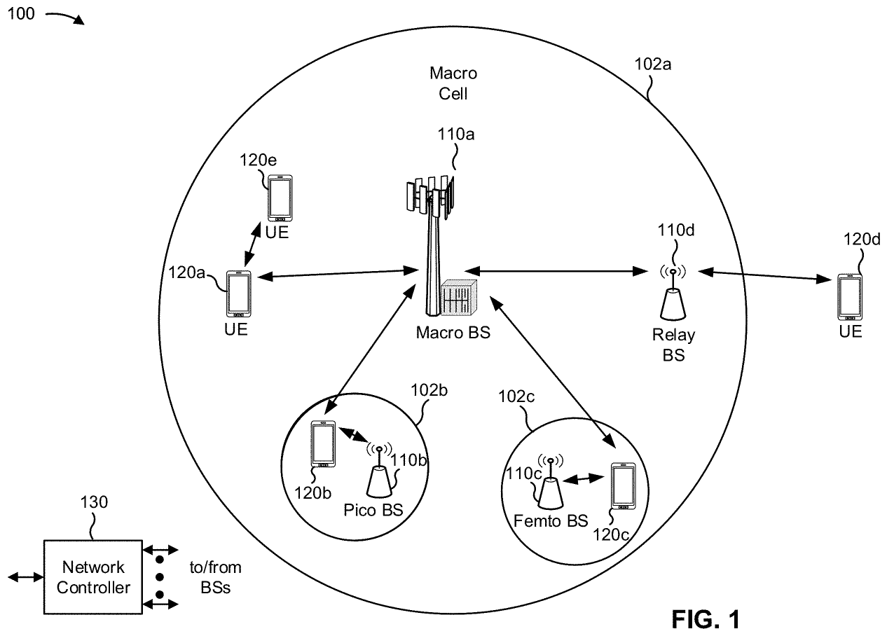

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, etc.

Wireless network 100 may be a heterogeneous network that includes BSs of different types, e.g., macro BSs, pico BSs, femto BSs, relay BSs, etc. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. Some UEs may operate in a low power mode, such as a sleep state of a CDRX mode.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

In some examples, access to the air interface may be scheduled, wherein a scheduling entity (e.g., a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided merely as an example. Other examples may differ from what is described with regard to FIG. 1.

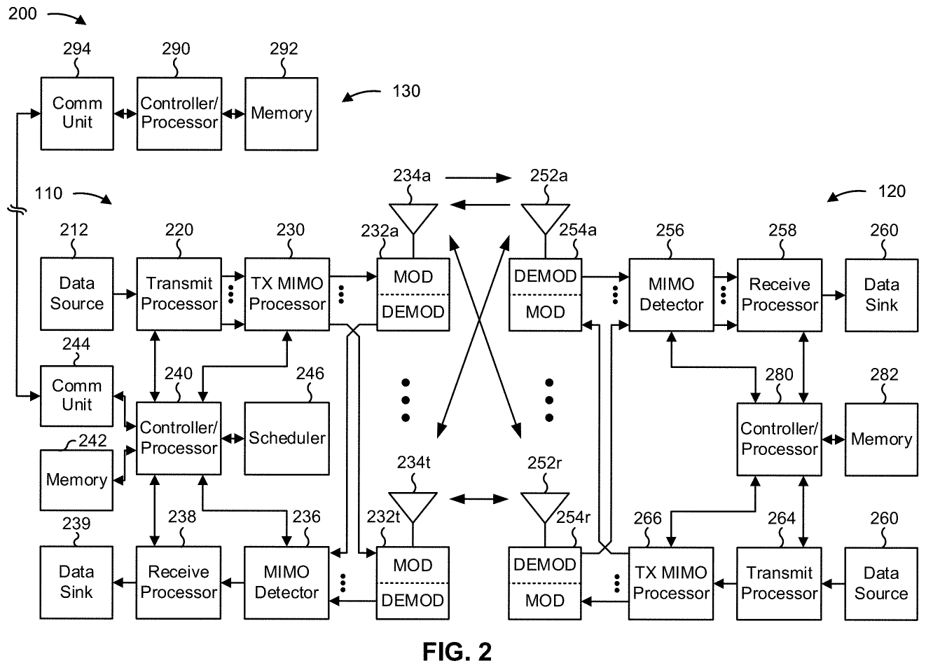

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS selected for the UE, and provide data symbols for all UEs. Transmit processor 220 may also process system information (e.g., for semi-static resource partitioning information (SRPI), and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. For example, UE 120 may receive wake up signaling, RRC signaling, and/or the like. Each demodulator 254 may condition (e.g., filter, amplify, downconvert, and digitize) a received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), etc. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

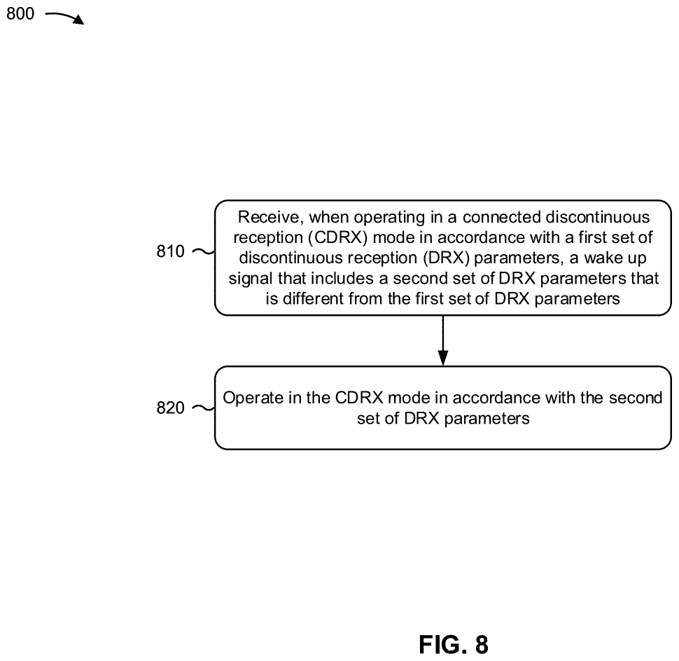

Controller/processor 240 of base station 110, controller/processor 280 of UE 120, and/or any other component(s) of FIG. 2 may perform one or more techniques associated with DRX parameter adaptation using wake up signaling, as described in more detail elsewhere herein. For example, controller/processor 240 of base station 110, controller/processor 280 of UE 120, and/or any other component(s) of FIG. 2 may perform or direct operations of, for example, process 800 of FIG. 8 and/or other processes as described herein. Memories 242 and 282 may store data and program codes for base station 110 and UE 120, respectively. A scheduler 246 may schedule UEs for data transmission on the downlink and/or uplink.

The stored program codes, when executed by processor 280 and/or other processors and modules at UE 120, may cause the UE 120 to perform operations described with respect to process 800 of FIG. 8 and/or other processes as described herein. A scheduler 246 may schedule UEs for data transmission on the downlink and/or uplink.

In some aspects, UE 120 may include means for receiving, when operating in a connected discontinuous reception (CDRX) mode in accordance with a first set of discontinuous reception (DRX) parameters, a wake up signal that includes a second set of DRX parameters that is different from the first set of DRX parameters, means for operating in the CDRX mode in accordance with the second set of DRX parameters, and/or the like. In some aspects, such means may include one or more components of UE 120 described in connection with FIG. 2.

While blocks in FIG. 2 are illustrated as distinct components, the functions described above with respect to the blocks may be implemented in a single hardware, software, or combination component, or in various combinations of components. For example, the functions described with respect to the transmit processor 264, the receive processor 258, and/or the TX MIMO processor 266 may be performed by or under the control of processor 280.

As indicated above, FIG. 2 is provided merely as an example. Other examples may differ from what is described with regard to FIG. 2.

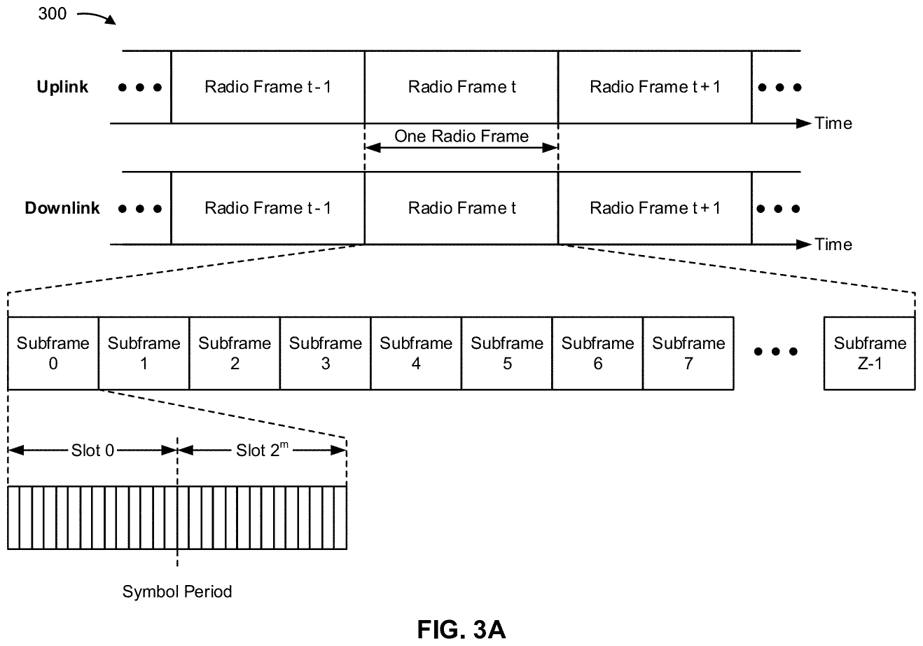

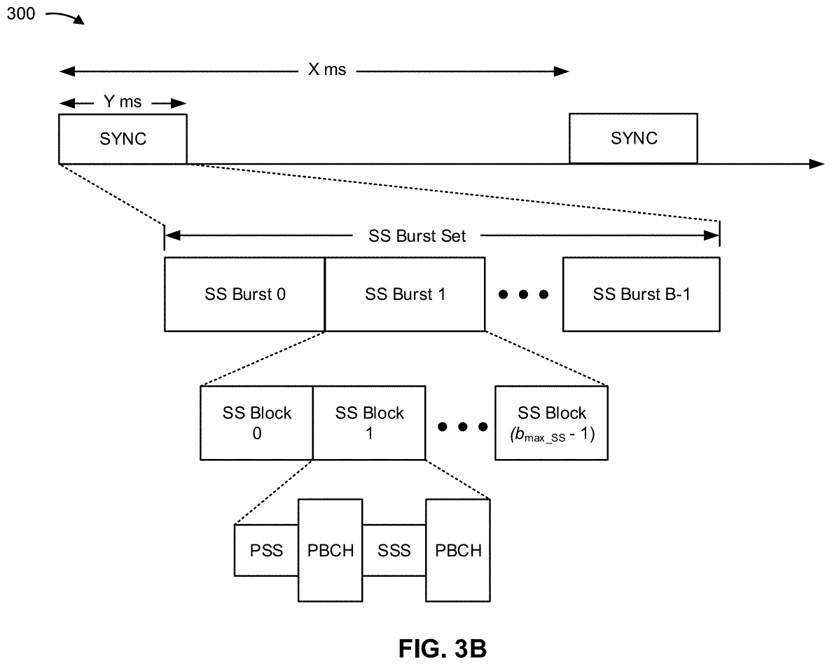

FIG. 3A shows an example frame structure 300 for frequency division duplexing (FDD) in a telecommunications system (e.g., NR). The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z−1). Each subframe may have a predetermined duration (e.g., 1 ms) and may include a set of slots (e.g., 2^{m} slots per subframe are shown in FIG. 3A, where m is a numerology used for a transmission, such as 0, 1, 2, 3, 4, and/or the like). Each slot may include a set of L symbol periods. For example, each slot may include fourteen symbol periods (e.g., as shown in FIG. 3A), seven symbol periods, or another number of symbol periods. In a case where the subframe includes two slots (e.g., when m=1), the subframe may include 2L symbol periods, where the 2L symbol periods in each subframe may be assigned indices of 0 through 2L−1. In some aspects, a scheduling unit for the FDD may frame-based, subframe-based, slot-based, symbol-based, and/or the like.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol. Additionally, or alternatively, different configurations of wireless communication structures than those shown in FIG. 3A may be used.

In certain telecommunications (e.g., NR), a base station may transmit synchronization signals. For example, a base station may transmit a primary synchronization signal (PSS), a secondary synchronization signal (SSS), and/or the like, on the downlink for each cell supported by the base station. The PSS and SSS may be used by UEs for cell search and acquisition. For example, the PSS may be used by UEs to determine symbol timing, and the SSS may be used by UEs to determine a physical cell identifier, associated with the base station, and frame timing. The base station may also transmit a physical broadcast channel (PBCH). The PBCH may carry some system information, such as system information that supports initial access by UEs.

In some aspects, the base station may transmit the PSS, the SSS, and/or the PBCH in accordance with a synchronization communication hierarchy (e.g., a synchronization signal (SS) hierarchy) including multiple synchronization communications (e.g., SS blocks), as described below in connection with FIG. 3B.

FIG. 3B is a block diagram conceptually illustrating an example SS hierarchy, which is an example of a synchronization communication hierarchy. As shown in FIG. 3B, the SS hierarchy may include an SS burst set, which may include a plurality of SS bursts (identified as SS burst 0 through SS burst B−1, where B is a maximum number of repetitions of the SS burst that may be transmitted by the base station). As further shown, each SS burst may include one or more SS blocks (identified as SS block 0 through SS block (b_{max_SS}−1), where b_{max_SS}−1 is a maximum number of SS blocks that can be carried by an SS burst). In some aspects, different SS blocks may be beam-formed differently. An SS burst set may be periodically transmitted by a wireless node, such as every X milliseconds, as shown in FIG. 3B. In some aspects, an SS burst set may have a fixed or dynamic length, shown as Y milliseconds in FIG. 3B.

The SS burst set shown in FIG. 3B is an example of a synchronization communication set, and other synchronization communication sets may be used in connection with the techniques described herein. Furthermore, the SS block shown in FIG. 3B is an example of a synchronization communication, and other synchronization communications may be used in connection with the techniques described herein.

In some aspects, an SS block includes resources that carry the PSS, the SSS, the PBCH, and/or other synchronization signals (e.g., a tertiary synchronization signal (TSS)) and/or synchronization channels. In some aspects, multiple SS blocks are included in an SS burst, and the PSS, the SSS, and/or the PBCH may be the same across each SS block of the SS burst. In some aspects, a single SS block may be included in an SS burst. In some aspects, the SS block may be at least four symbol periods in length, where each symbol carries one or more of the PSS (e.g., occupying one symbol), the SSS (e.g., occupying one symbol), and/or the PBCH (e.g., occupying two symbols).

In some aspects, the symbols of an SS block are consecutive, as shown in FIG. 3B. In some aspects, the symbols of an SS block are non-consecutive. Similarly, in some aspects, one or more SS blocks of the SS burst may be transmitted in consecutive radio resources (e.g., consecutive symbol periods) during one or more slots. Additionally, or alternatively, one or more SS blocks of the SS burst may be transmitted in non-consecutive radio resources.

In some aspects, the SS bursts may have a burst period, whereby the SS blocks of the SS burst are transmitted by the base station according to the burst period. In other words, the SS blocks may be repeated during each SS burst. In some aspects, the SS burst set may have a burst set periodicity, whereby the SS bursts of the SS burst set are transmitted by the base station according to the fixed burst set periodicity. In other words, the SS bursts may be repeated during each SS burst set.

The base station may transmit system information, such as system information blocks (SIBs) on a physical downlink shared channel (PDSCH) in certain slots. The base station may transmit control information/data on a physical downlink control channel (PDCCH) in C symbol periods of a slot, where B may be configurable for each slot. For example, the base station may use a PDCCH to convey a wake up signal to a UE. The base station may transmit traffic data and/or other data on the PDSCH in the remaining symbol periods of each slot.

As indicated above, FIGS. 3A and 3B are provided as examples. Other examples may differ from what is described with regard to FIGS. 3A and 3B.

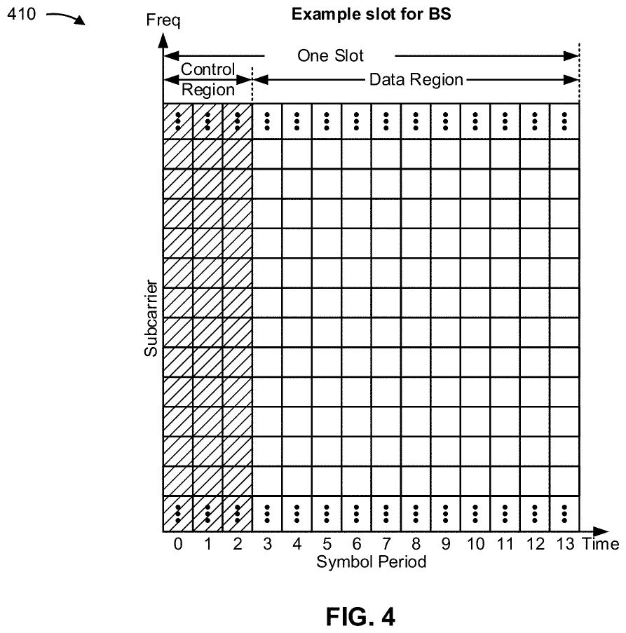

FIG. 4 shows an example slot format 410 with a normal cyclic prefix. The available time frequency resources may be partitioned into resource blocks. Each resource block may cover a set of subcarriers (e.g., 12 subcarriers) in one slot and may include a number of resource elements. Each resource element may cover one subcarrier in one symbol period (e.g., in time) and may be used to send one modulation symbol, which may be a real or complex value.

An interlace structure may be used for each of the downlink and uplink for FDD in certain telecommunications systems (e.g., NR). For example, Q interlaces with indices of 0 through Q−1 may be defined, where Q may be equal to 4, 6, 8, 10, or some other value. Each interlace may include slots that are spaced apart by Q frames. In particular, interlace q may include slots q, q+Q, q+2Q, etc., where q∈{0, . . . , Q−1}.

A UE may be located within the coverage of multiple BSs. One of these BSs may be selected to serve the UE. The serving BS may be selected based at least in part on various criteria such as received signal strength, received signal quality, path loss, and/or the like. Received signal quality may be quantified by a signal-to-noise-and-interference ratio (SNIR), or a reference signal received quality (RSRQ), or some other metric. The UE may operate in a dominant interference scenario in which the UE may observe high interference from one or more interfering BSs.

While aspects of the examples described herein may be associated with NR or 5G technologies, aspects of the present disclosure may be applicable with other wireless communication systems. New Radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). In aspects, NR may utilize OFDM with a CP (herein referred to as cyclic prefix OFDM or CP-OFDM) and/or SC-FDM on the uplink, may utilize CP-OFDM on the downlink and include support for half-duplex operation using TDD. In aspects, NR may, for example, utilize OFDM with a CP (herein referred to as CP-OFDM) and/or discrete Fourier transform spread orthogonal frequency-division multiplexing (DFT-s-OFDM) on the uplink, may utilize CP-OFDM on the downlink and include support for half-duplex operation using TDD. NR may include Enhanced Mobile Broadband (eMBB) service targeting wide bandwidth (e.g., 80 megahertz (MHz) and beyond), millimeter wave (mmW) targeting high carrier frequency (e.g., 60 gigahertz (GHz)), massive MTC (mMTC) targeting non-backward compatible MTC techniques, and/or mission critical targeting ultra reliable low latency communications (URLLC) service.

In some aspects, a single component carrier bandwidth of 100 MHz may be supported. NR resource blocks may span 12 sub-carriers with a sub-carrier bandwidth of 60 or 120 kilohertz (kHz) over a 0.1 millisecond (ms) duration. Each radio frame may include 40 slots and may have a length of 10 ms. Consequently, each slot may have a length of 0.25 ms. Each slot may indicate a link direction (e.g., DL or UL) for data transmission and the link direction for each slot may be dynamically switched. Each slot may include DL/UL data as well as DL/UL control data.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface. NR networks may include entities such as central units or distributed units.

As indicated above, FIG. 4 is provided as an example. Other examples may differ from what is described with regard to FIG. 4.

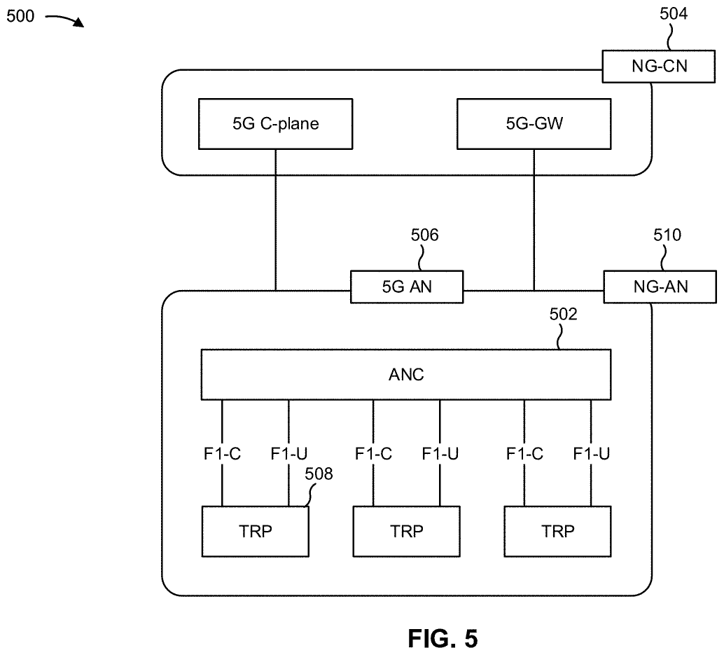

FIG. 5 illustrates an example logical architecture of a distributed RAN 500, according to aspects of the present disclosure. A 5G access node 506 may include an access node controller (ANC) 502. The ANC may be a central unit (CU) of the distributed RAN 500. The backhaul interface to the next generation core network (NG-CN) 504 may terminate at the ANC. The backhaul interface to neighboring next generation access nodes (NG-ANs) may terminate at the ANC. The ANC may include one or more TRPs 508 (which may also be referred to as BSs, NR BSs, Node Bs, 5G NBs, APs, gNB, or some other term). As described above, “TRP” may be used interchangeably with “cell.”

The TRPs 508 may be a distributed unit (DU). The TRPs may be connected to one ANC (ANC 502) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of RAN 500 may be used to illustrate fronthaul definition. The architecture may be defined that support fronthauling solutions across different deployment types. For example, the architecture may be based at least in part on transmit network capabilities (e.g., bandwidth, latency, and/or jitter).

The architecture may share features and/or components with LTE. According to aspects, the next generation AN (NG-AN) 510 may support dual connectivity with NR. The NG-AN may share a common fronthaul for LTE and NR.

The architecture may enable cooperation between and among TRPs 508. For example, cooperation may be preset within a TRP and/or across TRPs via the ANC 502. According to aspects, no inter-TRP interface may be needed/present.

According to aspects, a dynamic configuration of split logical functions may be present within the architecture of RAN 500. The packet data convergence protocol (PDCP), radio link control (RLC), media access control (MAC) protocol may be adaptably placed at the ANC or TRP.

According to various aspects, a BS may include a central unit (CU) (e.g., ANC 502) and/or one or more distributed units (e.g., one or more TRPs 508).

As indicated above, FIG. 5 is provided merely as an example. Other examples may differ from what is described with regard to FIG. 5.

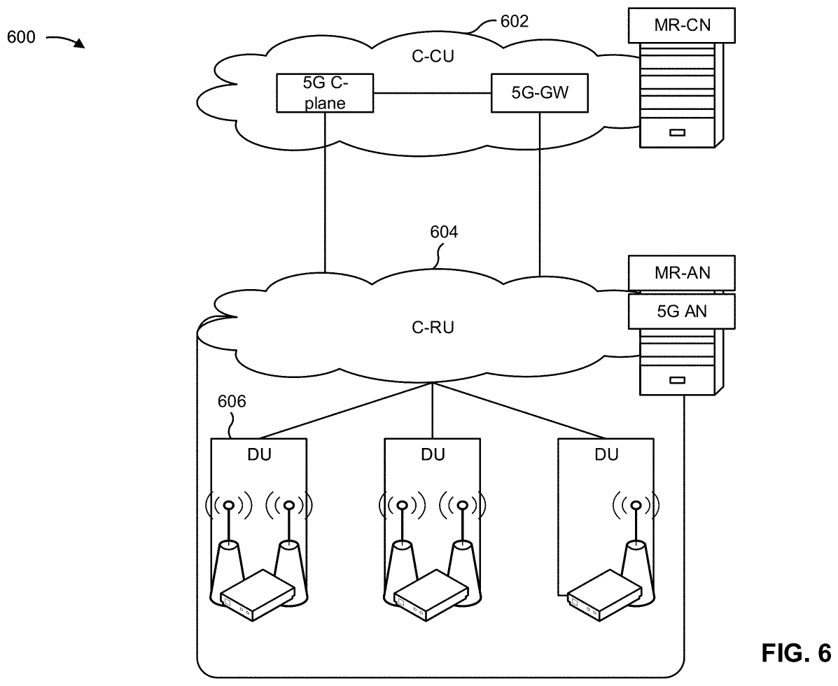

FIG. 6 illustrates an example physical architecture of a distributed RAN 600, according to aspects of the present disclosure. A centralized core network unit (C-CU) 602 may host core network functions. The C-CU may be centrally deployed. C-CU functionality may be offloaded (e.g., to advanced wireless services (AWS)), in an effort to handle peak capacity.

A centralized RAN unit (C-RU) 604 may host one or more ANC functions. Optionally, the C-RU may host core network functions locally. The C-RU may have distributed deployment. The C-RU may be closer to the network edge.

A distributed unit (DU) 606 may host one or more TRPs. The DU may be a single unit located at edges of the network with radio frequency (RF) functionality.

As indicated above, FIG. 6 is provided merely as an example. Other examples may differ from what is described with regard to FIG. 6.

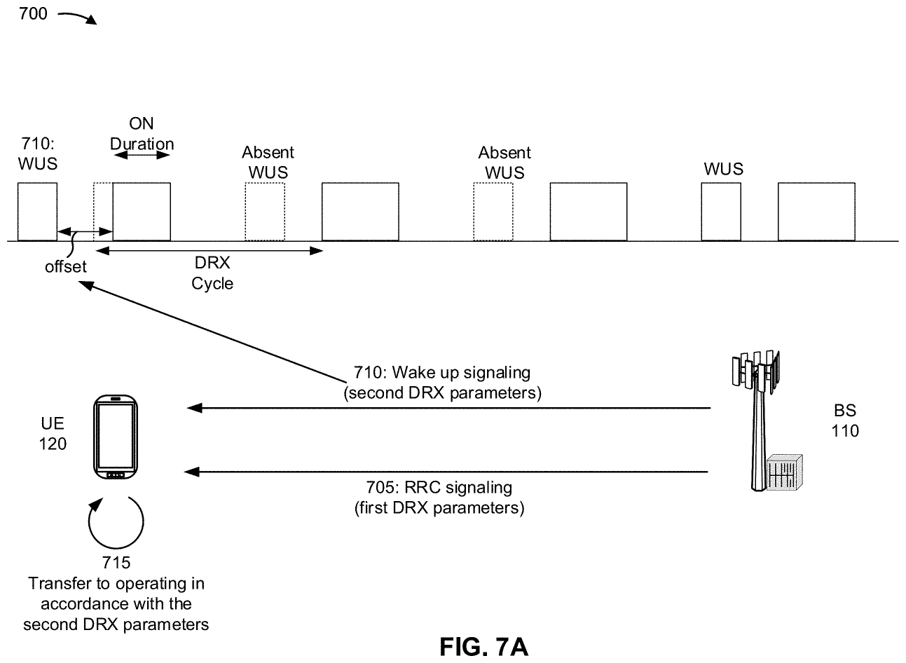

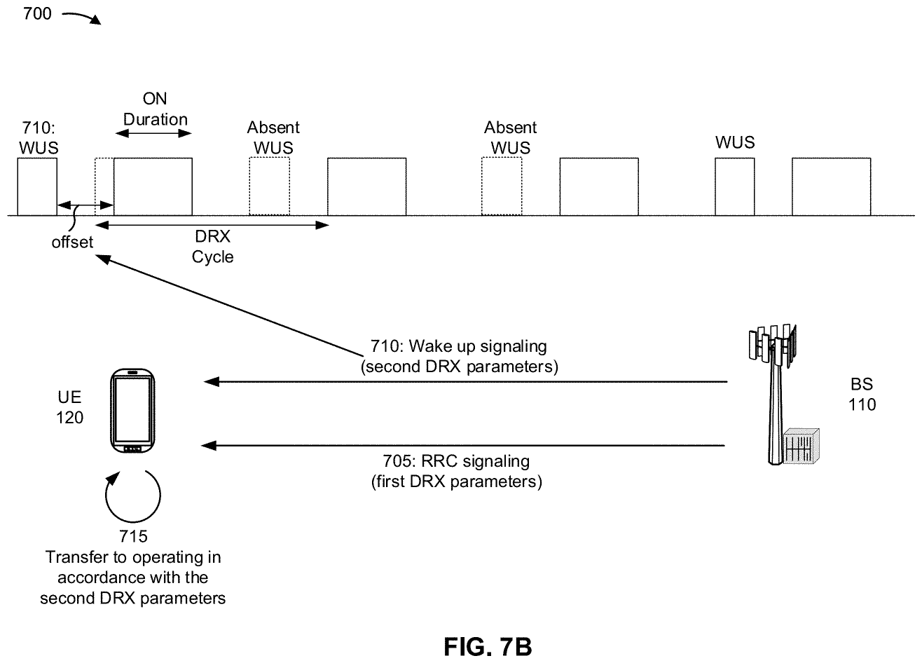

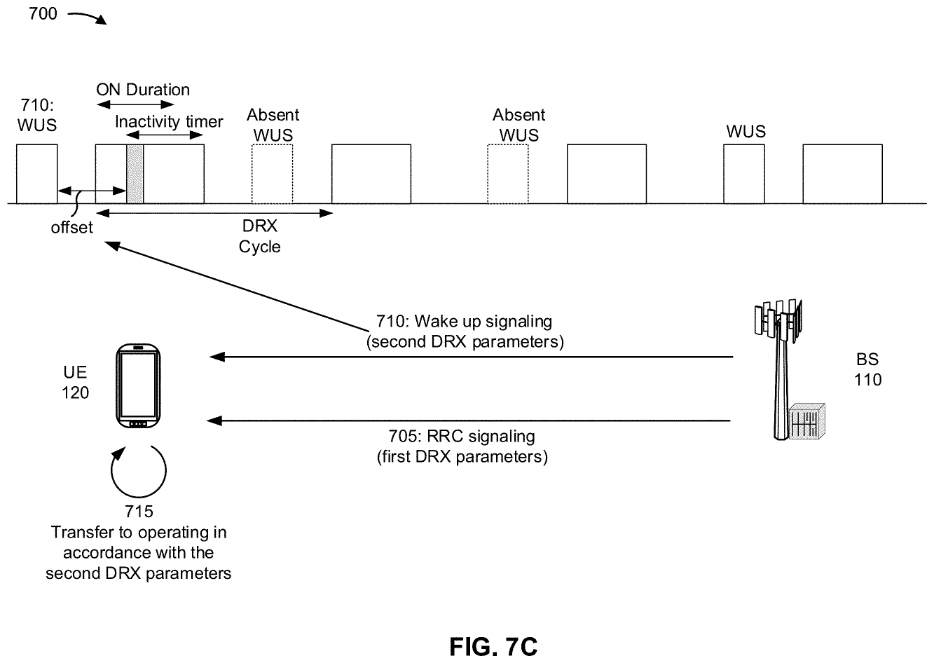

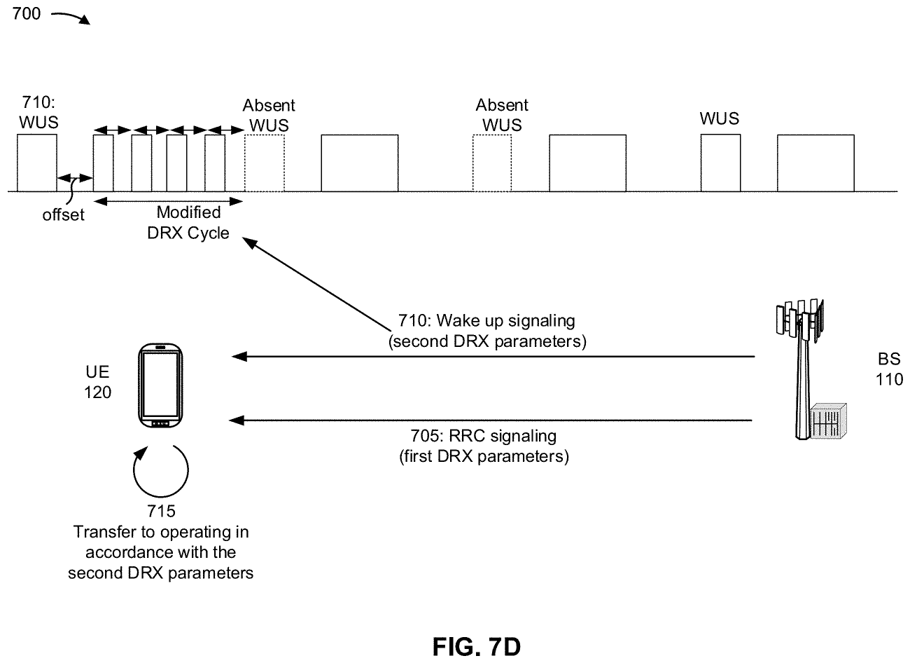

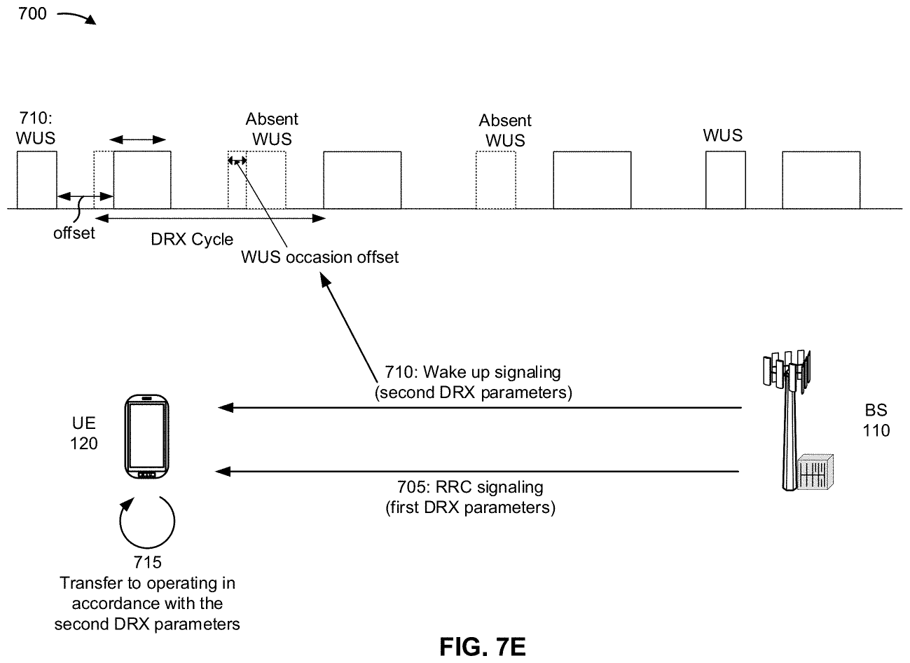

FIGS. 7A-7E are diagrams illustrating examples 700 of DRX parameter adaptation using wake up signaling, in accordance with various aspects of the present disclosure. As shown in FIGS. 7A-7E, examples 700 include a BS 110 and a UE 120.

As shown in FIG. 7A, and by reference number 705, UE 120 may receive information identifying a first set of DRX parameters for configuring a CDRX mode. For example, UE 120 may receive radio resource control (RRC) signaling associated with indicating the first set of DRX parameters for the CDRX mode. In this case, the first set of DRX parameters may include parameters for setting a DRX pattern, an offset between wake up signaling and an on duration, a pattern for wake up signaling occasions, and/or the like. In some aspects, UE 120 may communicate with BS 110 in accordance with the first set of DRX parameters. For example, UE 120 may operate in a sleep state, a wake state, and/or the like for a set of on durations and off durations of the CDRX mode in accordance with the first set of DRX parameters.

As further shown in FIG. 7A, and by reference number 710, UE 120 may receive a wake up signal including a second set of DRX parameters. For example, UE 120 may receive the wake up signal during a wake up signaling occasion scheduled in accordance with the first set of DRX parameters. In this case, BS 110 may transmit, to convey the wake up signal, a channel state information reference signal (CSI-RS), a physical downlink control signal (PDCCH), and/or the like.

In some aspects, the wake up signal may include one or more fields or sequences identifying the second set of DRX parameters. For example, the wake up signal may include a bit indicator of whether to start an on duration timer, a size of a bandwidth part, an identity of an active bandwidth part, an offset regarding when to monitor for a PDCCH, a search space set to monitor, a DRX pattern, and/or the like. In some aspects, the second set of DRX parameters may be a subset of the first set of DRX parameters. For example, BS 110 may transmit the second set of DRX parameters to identify changes to the first set of DRX parameters, and may omit one or more DRX parameters from the second set of DRX parameters that are not to change from the first set of DRX parameters. In other words, in some aspects, BS 110 may transmit only DRX parameters, of the first set of DRX parameters, that change, which conserves resources of UE 120, resources of BS 110, and network resources that would otherwise be used to transmit, receive, and/or process DRX parameters, of the first set of DRX parameters, that did not change.

In some aspects, UE 120 may determine a parameter change based at least in part on the wake up signaling identifying the second set of DRX parameters. For example, as shown in FIG. 7A, UE 120 may determine a change to an offset between a wake up signaling occasion and a time when UE 120 is to wake up. In this case, UE 120 may determine to increase a size of the on duration by waking up before the on duration starts, thereby increasing an amount of downlink data traffic that UE 120 may receive. Alternatively, UE 120 may determine to wake up at a time during the on duration, thereby remaining in a sleep state for a greater period of time and reducing power consumption.

Additionally, or alternatively, UE 120 may determine to change an offset between the wake up signal and a time when the on duration starts (e.g., without altering a size of the on duration). For example, as shown in FIG. 7B, UE 120 may determine that the on duration is to occur at a later time than was configured based at least in part on the first set of DRX parameters. Alternatively, UE 120 may determine that the on duration is to occur at an earlier time than was configured based at least in part on the first set of DRX parameters. In this way, UE 120 increases scheduling flexibility. For example, BS 110 may configure offsets for on durations for a plurality of UEs 120 to stagger the on durations of the plurality of UEs 120 to avoid interference between communications to the plurality of UEs 120.

Additionally, or alternatively, UE 120 may determine to alter an inactivity timer configuration based at least in part on the second set of DRX parameters. For example, as shown in FIG. 7C, UE 120 may configure an inactivity timer to start at a particular time during an on duration. In this case, the particular time may be defined by an offset value from a wake up signaling occasion, which may be indicated by the second set of DRX parameters and may be different from an offset indicated by the first set of DRX parameters. In this way, BS 110 may use information regarding the downlink data traffic pattern for UE 120 to avoid UE 120 remaining in a wake state when there is not data for UE 120 to receive, thereby reducing power utilization. Further, BS 110 may avoid UE 120 entering a sleep state when there is data for UE 120 to receive, thereby reducing a likelihood of dropped data.

Additionally, or alternatively, UE 120 may alter a DRX pattern based at least in part on the second set of DRX parameters. For example, as shown in FIG. 7D, UE 120 may determine to operate in accordance with a modified DRX cycle that includes on durations (e.g., which may be termed miniature on durations) and off durations (e.g., which may be termed miniature off durations) within a period defined for a single DRX cycle by the first set of DRX parameters. In this way, BS 110 may account for a relatively high downlink data traffic pattern.

Additionally, or alternatively, UE 120 may alter a timing for a subsequent wake up signaling occasion based at least in part on the second set of DRX parameters. For example, as shown in FIG. 7E, UE 120 may determine that a next wake up signaling occasion is scheduled for a time period after when the next wake up signaling occasion was scheduled in accordance with the first set of DRX parameters. Alternatively, UE 120 may determine that the next wake up signaling occasion is scheduled for earlier than when the next wake up signaling occasion was scheduled in accordance with the first set of DRX parameters. Additionally, or alternatively, UE 120 may determine to skip a next wake up signaling occasion, thereby reducing power utilization when BS 110 is not to transmit a wake up signal during the next wake up signaling occasion.

Returning to FIG. 7A, and as shown by reference number 715, UE 120 may operate in accordance with the second set of DRX parameters. For example, UE 120 may transfer to a wake state, operate in an on duration, monitor for a subsequent wake up signal, operate according to a modified DRX cycle, and/or the like in accordance with the second set of DRX parameters. In this way, UE 120 enables adaptation of a CDRX mode configuration with a reduced activation delay and/or a reduced deactivation delay relative to using RRC signaling to reconfigure the CDRX mode.

As indicated above, FIGS. 7A-7E are provided as examples. Other examples may differ from what is described with respect to FIGS. 7A-7E.

FIG. 8 is a diagram illustrating an example process 800 performed, for example, by a UE, in accordance with various aspects of the present disclosure. Example process 800 is an example where a UE (e.g., UE 120 and/or the like) performs operations associated with discontinuous reception parameter adaptation using wake up signaling.

As shown in FIG. 8, in some aspects, process 800 may include receiving, when operating in a connected discontinuous reception (CDRX) mode in accordance with a first set of discontinuous reception (DRX) parameters, a wake up signal that includes a second set of DRX parameters that is different from the first set of DRX parameters (block 810). For example, the UE (e.g., using receive processor 258, controller/processor 280, memory 282, and/or the like) may receive, when operating in a connected discontinuous reception (CDRX) mode in accordance with a first set of discontinuous reception (DRX) parameters, a wake up signal that includes a second set of DRX parameters that is different from the first set of DRX parameters, as described above.

As further shown in FIG. 8, in some aspects, process 800 may include operating in the CDRX mode in accordance with the second set of DRX parameters (block 820). For example, the UE (e.g., using receive processor 258, transmit processor 264, controller/processor 280, memory 282, and/or the like) may operate in the CDRX mode in accordance with the second set of DRX parameters, as described above.

Process 800 may include additional aspects, such as any single implementation or any combination of aspects described below and/or in connection with one or more other processes described elsewhere herein.

In a first aspect, process 800 may include receiving, before receiving the wake up signal, the first set of DRX parameters via a radio resource control message. In a second aspect, alone or in combination with the first aspect, process 800 may include operating in the CDRX mode in accordance with the first set of DRX parameters before receiving the wake up signaling. In a third aspect, alone or in combination with one or more of the first and second aspects, the wake up signal is received via a physical downlink control channel or a channel state information reference signal.

In a fourth aspect, alone or in combination with one or more of the first through third aspects, operating in the CDRX mode in accordance with the second set of DRX parameters may include waking up, based at least in part on the second set of DRX parameters, during an on duration a threshold offset period of time after a start of the on duration, such that a length of the on duration is shortened relative to a configured length of the on duration indicated in the first set of DRX parameters. In a fifth aspect, alone or in combination with one or more of the first through fourth aspects, operating in the CDRX mode in accordance with the second set of DRX parameters may include starting, based at least in part on the second set of DRX parameters, an on duration a threshold offset period of time after a configured start of the on duration indicated in the first set of DRX parameters.

In a sixth aspect, alone or in combination with one or more of the first through fifth aspects, operating in the CDRX mode in accordance with the second set of DRX parameters may include operating, based at least in part on the second set of DRX parameters, in an awake mode for a threshold period of time that is longer than a configured period of time indicated in the first set of DRX parameters. In a seventh aspect, alone or in combination with one or more of the first through sixth aspects, operating in the CDRX mode in accordance with the second set of DRX parameters may include operating, based at least in part on the second set of DRX parameters, in a sleep mode for a period of time for which downlink data is available. In an eighth aspect, alone or in combination with one or more of the first through seventh aspects, the second set of DRX parameters includes an inactivity timer parameter to alter an operation of the UE with respect to an inactivity timer.

In a ninth aspect, alone or in combination with one or more of the first through eighth aspects, the second set of DRX parameters includes a DRX pattern parameter to alter a pattern of DRX operation of the UE. In a tenth aspect, alone or in combination with one or more of the first through ninth aspects, operating in the CDRX mode in accordance with the second set of DRX parameters may include operating, based at least in part on the second set of DRX parameters, in a modified DRX cycle including a plurality of on durations and a plurality of off durations during a single configured DRX cycle configured in accordance with the first set of DRX parameters. In an eleventh aspect, alone or in combination with one or more of the first through tenth aspects, operating in the CDRX mode in accordance with the second set of DRX parameters may include receiving, based at least in part on the second set of DRX parameters, a subsequent wake up signal at a particular wake up signaling occasion offset by a threshold period of time from a configured wake up signaling occasion configured in accordance with the first set of DRX parameters.

In a twelfth aspect, alone or in combination with one or more of the first through eleventh aspects, the second set of DRX parameters includes information identifying changes to a subset of the first set of DRX parameters and does not include information identifying one or more parameters, of the first set of DRX parameters, that are not to change. In a thirteenth aspect, alone or in combination with one or more of the first through twelfth aspects, an activation delay or a deactivation delay in accordance with the second set of DRX parameters is less than a configured activation delay or a configured deactivation delay in accordance with the first set of DRX parameters. In a fourteenth aspect, alone or in combination with one or more of the first through thirteenth aspects, the second set of DRX parameters include a parameter associated with modifying at least one of an offset, an on duration, a DRX cycle, a DRX pattern, a CDRX length, or, a wake up signaling occasion.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving, when operating in a connected discontinuous reception (CDRX) mode in accordance with a first set of discontinuous reception (DRX) parameters, a wake up signal that includes a second set of DRX parameters that is different from the first set of DRX parameters; and
operating in the CDRX mode in accordance with the second set of DRX parameters.

2. The method of claim 1, further comprising:
receiving, before receiving the wake up signal, the first set of DRX parameters via a radio resource control message; and
operating in the CDRX mode in accordance with the first set of DRX parameters before receiving the wake up signal.

3. The method of claim 1, wherein the wake up signal is received via a physical downlink control channel or a channel state information reference signal.

4. The method of claim 1, wherein operating in the CDRX mode in accordance with the second set of DRX parameters comprises:
waking up, based at least in part on the second set of DRX parameters, during an on duration a threshold offset period of time after a start of the on duration, such that a length of the on duration is shortened relative to a configured length of the on duration indicated in the first set of DRX parameters.

5. The method of claim 1, wherein operating in the CDRX mode in accordance with the second set of DRX parameters comprises:
starting, based at least in part on the second set of DRX parameters, an on duration a threshold offset period of time after a configured start of the on duration indicated in the first set of DRX parameters.

6. The method of claim 1, wherein operating in the CDRX mode in accordance with the second set of DRX parameters comprises:
operating, based at least in part on the second set of DRX parameters, in an awake mode for a threshold period of time that is longer than a configured period of time indicated in the first set of DRX parameters.

7. The method of claim 1, wherein operating in the CDRX mode in accordance with the second set of DRX parameters comprises:
operating, based at least in part on the second set of DRX parameters, in a sleep mode for a period of time for which downlink data is available.

8. The method of claim 1, wherein the second set of DRX parameters includes an inactivity timer parameter to alter an operation of the UE with respect to an inactivity timer.

9. The method of claim 1, wherein the second set of DRX parameters includes a DRX pattern parameter to alter a pattern of DRX operation of the UE.

10. The method of claim 1, wherein operating in the CDRX mode in accordance with the second set of DRX parameters comprises:
operating, based at least in part on the second set of DRX parameters, in a modified DRX cycle including a plurality of on durations and a plurality of off durations during a single configured DRX cycle configured in accordance with the first set of DRX parameters.

11. The method of claim 1, wherein operating in the CDRX mode in accordance with the second set of DRX parameters comprises:
receiving, based at least in part on the second set of DRX parameters, a subsequent wake up signal at a particular wake up signaling occasion offset by a threshold period of time from a configured wake up signaling occasion configured in accordance with the first set of DRX parameters.

12. The method of claim 1, wherein the second set of DRX parameters includes information identifying changes to a subset of the first set of DRX parameters and does not include information identifying one or more parameters, of the first set of DRX parameters, that are not to change.

13. The method of claim 1, an activation delay or a deactivation delay in accordance with the second set of DRX parameters is less than a configured activation delay or a configured deactivation delay in accordance with the first set of DRX parameters.

14. The method of claim 1, wherein the second set of DRX parameters include a parameter associated with modifying at least one of:
an offset,
an on duration
a DRX cycle,
a DRX pattern,
a CDRX length, or
a wake up signaling occasion.

15. A user equipment (UE) for wireless communication, comprising:
a memory; and
one or more processors operatively coupled to the memory, the memory and the one or more processors configured to:
receive, when operating in a connected discontinuous reception (CDRX) mode in accordance with a first set of discontinuous reception (DRX) parameters, a wake up signal that includes a second set of DRX parameters that is different from the first set of DRX parameters; and
operate in the CDRX mode in accordance with the second set of DRX parameters.

16. The UE of claim 15, wherein the one or more processors are further configured to:
receive, before receiving the wake up signal, the first set of DRX parameters via a radio resource control message; and
operate in the CDRX mode in accordance with the first set of DRX parameters before receiving the wake up signal.

17. The UE of claim 15, wherein the wake up signal is received via a physical downlink control channel or a channel state information reference signal.

18. The UE of claim 15, wherein the one or more processors, when operating in the CDRX mode in accordance with the second set of DRX parameters, are to:
wake up, based at least in part on the second set of DRX parameters, during an on duration a threshold offset period of time after a start of the on duration, such that a length of the on duration is shortened relative to a configured length of the on duration indicated in the first set of DRX parameters.

19. The UE of claim 15, wherein the one or more processors, when operating in the CDRX mode in accordance with the second set of DRX parameters, are to:
start, based at least in part on the second set of DRX parameters, an on duration a threshold offset period of time after a configured start of the on duration indicated in the first set of DRX parameters.

20. The UE of claim 15, wherein the one or more processors, when operating in the CDRX mode in accordance with the second set of DRX parameters, are to:
operate, based at least in part on the second set of DRX parameters, in an awake mode for a threshold period of time that is longer than a configured period of time indicated in the first set of DRX parameters.

21. A non-transitory computer-readable medium storing one or more instructions for wireless communication, the one or more instructions comprising:
one or more instructions that, when executed by one or more processors of a user equipment (UE), cause the one or more processors to:
receive, when operating in a connected discontinuous reception (CDRX) mode in accordance with a first set of discontinuous reception (DRX) parameters, a wake up signal that includes a second set of DRX parameters that is different from the first set of DRX parameters; and
operate in the CDRX mode in accordance with the second set of DRX parameters.

22. The non-transitory computer-readable medium of claim 21, wherein the one or more instructions, when executed by the one or more processors, further cause the one or more processors to:
receive, before receiving the wake up signal, the first set of DRX parameters via a radio resource control message; and
operate in the CDRX mode in accordance with the first set of DRX parameters before receiving the wake up signal.

23. The non-transitory computer-readable medium of claim 21, wherein the wake up signal is received via a physical downlink control channel or a channel state information reference signal.

24. The non-transitory computer-readable medium of claim 21, wherein the one or more instructions, that cause the one or more processors to operate in the CDRX mode in accordance with the second set of DRX parameters, further cause the one or more processors to:
wake up, based at least in part on the second set of DRX parameters, during an on duration a threshold offset period of time after a start of the on duration, such that a length of the on duration is shortened relative to a configured length of the on duration indicated in the first set of DRX parameters.

25. The non-transitory computer-readable medium of claim 21, wherein the one or more instructions, that cause the one or more processors to operate in the CDRX mode in accordance with the second set of DRX parameters, further cause the one or more processors to:
start, based at least in part on the second set of DRX parameters, an on duration a threshold offset period of time after a configured start of the on duration indicated in the first set of DRX parameters.

26. An apparatus for wireless communication, comprising:
means for receiving, when operating in a connected discontinuous reception (CDRX) mode in accordance with a first set of discontinuous reception (DRX) parameters, a wake up signal that includes a second set of DRX parameters that is different from the first set of DRX parameters; and
means for operating in the CDRX mode in accordance with the second set of DRX parameters.

27. The apparatus of claim 26, further comprising:
means for receiving, before receiving the wake up signal, the first set of DRX parameters via a radio resource control message; and
means for operating in the CDRX mode in accordance with the first set of DRX parameters before receiving the wake up signal.

28. The apparatus of claim 26, wherein the wake up signal is received via a physical downlink control channel or a channel state information reference signal.

29. The apparatus of claim 26, wherein the means for operating in the CDRX mode in accordance with the second set of DRX parameters comprises:
means for waking up, based at least in part on the second set of DRX parameters, during an on duration a threshold offset period of time after a start of the on duration, such that a length of the on duration is shortened relative to a configured length of the on duration indicated in the first set of DRX parameters.

30. The apparatus of claim 26, wherein the means for operating in the CDRX mode in accordance with the second set of DRX parameters comprises:
means for starting, based at least in part on the second set of DRX parameters, an on duration a threshold offset period of time after a configured start of the on duration indicated in the first set of DRX parameters.
